(19) United States
(12) Patent Application Publication
(10) Pub. No.: US 2011/0265576 A1
(43) Pub. Date: Nov. 3, 2011

(54) UROFLOWMETER ATTACHABLE TO TOILET

(76) Inventors: Eun Jong Cha, Cheongju-City (KR); Kyung Ah Kim, Cheongju-City (KR); Sang Bong Lee, Daegu (KR); Seong Su Choi, Cheongju-City (KR)

(21) Appl. No.: 13/091,388

(22) Filed: Apr. 21, 2011

(30) Foreign Application Priority Data
Apr. 30, 2010 (KR) 10-2010-0040525

(51) Int. Cl. G01L 7/00

(52) U.S. Cl. 73/700

(57) ABSTRACT

Disclosed is a uroflowmeter attachable to a toilet capable of diagnosing a BPH with high reliability and convenience in a sanitary way without the constraints of a space by checking the urinary flow rate of a patient. The uroflowmeter includes a toilet bowl for temporarily storing feces and urine, a connection tube which has one end introduced into water of the toilet bowl, a pressure measuring unit connected with an opposite end of the connection tube to measure pressure inside the toilet bowl, a signal analyzing unit for analyzing pressure signals from the pressure measuring unit to measure a urinary volume signal and a urinary flow rate signal, a display unit for displaying the urinary flow rate signal measured by the signal analyzing unit, and a wireless transceiver unit for making data communication with the signal analyzing unit in a wireless way.

### BACKGROUND OF THE INVENTION

1. Field of the Invention

The present invention relates to a uroflowmeter, and more particularly to a uroflowmeter attachable to a toilet capable of diagnosing a BPH (benign prostatic hypertrophy) with high reliability and convenience in a sanitary way without the constraints of a space by checking the urinary flow rate of a patient

2. Description of the Related Art

Prostate is a soft organism belonging to only men, placed under a bladder, and having the shape of a chestnut and the weight of about 20 g.

BPH (benign prostatic hypertrophy) refers to a disease of histopathology in which the size of the prostate is excessively increased. The BPH is a representative chronic adult disease of an aged society occurring among over 50-year old men.

A uroflowmetry is one of biometric examinations essentially performed when diagnosing the BPH.

FIG. 1 is a view a structure used to measure the urinary volume as a function of time in the uroflowmetry according to the related art, and FIG. 2 is a graph showing the calculation of parameters required when the BPH is diagnosed according to the related art.

The uroflowmetry is a test that measures the volume V of urine (or an amount of urine) collected in a container 11 as a function of time t when a human being urinates in the container 11 as shown in FIG. 1. The uroflowmetry is an essentially required biometric examination when the BPH is diagnosed.

If a function V(t) is differentiated with respect to a time (dV(t)/dt), the urinary flow rate may be obtained. In this case, as shown in FIG. 2, diagnosis parameters used to diagnose the BPH can be calculated. Representative diagnosis parameters include the maximum urinary flow rate Fmax and the average urinary flow rate Fmean.

As described above, the uroflowmetry is essentially required when diagnosing the BPH. Hereinafter, a uroflowmetry technology according to the related art will be described.

FIG. 3 is a view showing the uroflowmetry technology according to the related art, and FIG. 4 is a photograph showing a uroflowmeter to check the urinary flow rate based on a weight measuring scheme according to the related art. FIG. 5 is a view showing problems occurring in the uroflowmetry technology according to the related art.

The uroflowmetry according to the related art is performed by mainly measuring the weight of urine. According to a scheme of checking the urinary flow rate by using the uroflowmeter according to the related art, as shown in FIG. 3, urine is collected in a container 31 having a predetermined diameter, and a load-cell 32 serving as a sensor to measure the weight of the urine is provided under the container 31, thereby measuring the variation in the weight in the urination process. FIG. 4 is a photograph showing the uroflowmeter with the weight measuring scheme.

In general, urine has specific gravity of 1 approximately identical to that of water, a weight W is obtained as the product of a mass m and the acceleration g of gravity, and the mass m is obtained as the product of the specific gravity p and a volume V, so that the equation for the weight W is expressed as W=mg=ρVg. Then, an equation for the V is obtained as V=(1/ρg)W based on the equation, W=mg=ρVg. In this case, since ρ and g are constants, the volume V is proportional to the weight W. In other words, the weight of the urine is proportional to the volume of the urine. Accordingly, if the variation in urine weight is measured by collecting urine in the container 31 when the human being urinates, the signal for the variation in the urine volume, that is, the signal for an amount of urine can be obtained. The urine weight is measured in the form of an electrical signal by installing a sensor called the load cell 32 under the container 31 to measure the variation in the urine volume.

As described above, the uroflowmeter according to the related art continuously measures the variation in urine weight while receiving urine into the container 31 in the urination process.

Hereinafter, the procedure of checking the urinary flow rate by measuring the urine weight will be described.

W(t)=V(t)/(ρg)d/dt→F(t) analysis→Fmax and Fmean calculation.

The scheme of checking the urinary flow rate by using the uroflowmeter according to the related art has the following problems.

First, as shown in FIG. 5, if a patient releases urine into the container 31, so that the urine reaches the bottom surface of the container 31, the urine applies an impact to the bottom surface of the container 31. Therefore, the load-cell 32 provided under the container 31 measures impulse of the urine in addition to the weight of the collected urine. Since the urine having a liquid state is neither compressed nor expanded, the impulse applied to the surface of the urine collected by a predetermined quantity is transmitted to the bottom surface of the container 31 without change. Since such an impact effect is determined by various factors such as the flowing direction and speed of the urine, the impulse is represented as an unspecified value. Accordingly, the impact serves as a noise to prevent weight measurement, so that the weight of the urine cannot be exactly measured.

Second, in order to prevent the impact effect when the urine reaches the bottom surface of the container 31, urine may be flowed down along the wall surface of the container 31, thereby minimizing the impulse. However, in order to flow the urine down along the wall surface of the container 31, a well-designed funnel must be additionally used.

Third, since the container 31 must be emptied out for re-use after the uroflowmetry has been performed, the uroflowmetry scheme according to the related art is inconvenient and the container 31 is insanitary. If a patient touches the appliance part, examination reliability may be degraded.

Fourth, an additional installation space must be provided, and a urine collecting apparatus and a weight measuring apparatus must be installed.

Fifth, since a patient and an examinee stay in one space when the urinary flow rate of the patient is measured, the privacy of the patient may be invaded.

### SUMMARY OF THE INVENTION

Accordingly, the present invention has been made to solve the above problems occurring in the prior art, and an object of the present invention is to a uroflowmeter attachable to a toilet, which is convenient, sanitary, and installed without the constraints of a space because an additional urine collecting container is not required.

Another object of the present invention is to provide a uroflowmeter attachable to a toilet, capable of increasing measurement reliability by preventing impact noise when measuring a urinary flow rate.

Still another object of the present invention is to provide a uroflowmeter attachable to a toilet, capable of protecting the privacy of an individual.

In order to accomplish the above object, the present invention provides a uroflowmeter attachable to a toilet including a toilet bowl for temporarily storing feces and urine, a connection tube which has one end introduced into water of the toilet bowl, a pressure measuring unit connected with an opposite end of the connection tube to measure pressure inside the toilet bowl, a signal analyzing unit for analyzing pressure signals from the pressure measuring unit to measure a urinary volume signal and a urinary flow rate signal, a display unit for displaying the urinary flow rate signal measured by the signal analyzing unit, and a wireless transceiver unit for making data communication with the signal analyzing unit in a wireless way.

The uroflowmeter attachable to the toilet according to the present invention has the following effects.

First, a predetermined amount of water is always filled in a toilet bowl, and impulse is not delivered from a bottom surface of the toilet bowl because a scheme of measuring water pressure is applied. Accordingly, since impact noise is not caused, so that more reliable check results can be obtained as compared with a related art.

Second, an additional funnel and a urine collecting container are not required so that the structure of an appliance can be simplified. In addition, since there are not processes of cleaning the funnel or empting the urine collecting container, the check of the urinary flow rate can be more conveniently and sanitarily performed as compared with the related art.

Third, since the display unit is provided, the examinee can personally view the diagnosis parameters.

Fourth, the uroflowmeter can be installed in a toilet bowl, and wireless communication can be made, so that the privacy of an individual can be protected when the urinary flow rate is checked.

Fifth, since the uroflowmeter can be directly installed in a household toilet bowl, an additional space is not required differently from the related art.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing the structure of measuring a urinary volume as a function of time when a urinary flow rate is checked according to the related art;

FIG. 2 is a graph showing the calculation of parameters required when the BPH is diagnosed according to the related art;

FIG. 3 is a view showing a uroflowmetry technology according to the related art;

FIG. 4 is a photograph showing a uroflowmeter to check a urinary flow rate based on a weight measuring scheme according to the related art;

FIG. 5 is a view showing problems occurring in the uroflowmetry technology according to the related art;

FIG. 6 is a schematic view showing a scheme of measuring water pressure applied to the present invention;

FIG. 7 is a view showing the structure of a uroflowmeter attachable to a toilet according to an embodiment of the present invention;

FIG. 8 is a photograph showing that the uroflowmeter attachable to a toilet according to the embodiment of the present invention is installed in a toilet actually; and

FIGS. 9 to 11 are graphs showing a urinary pressure signal, a urinary volume signal, and a urinary flow rate signal measured by the uroflowmeter attachable to a toilet according to the present invention.

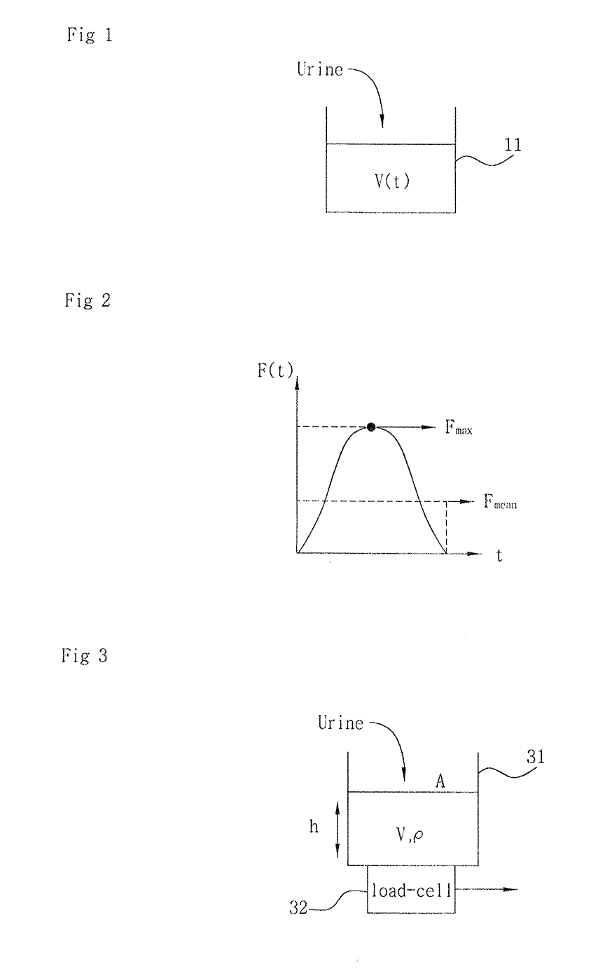

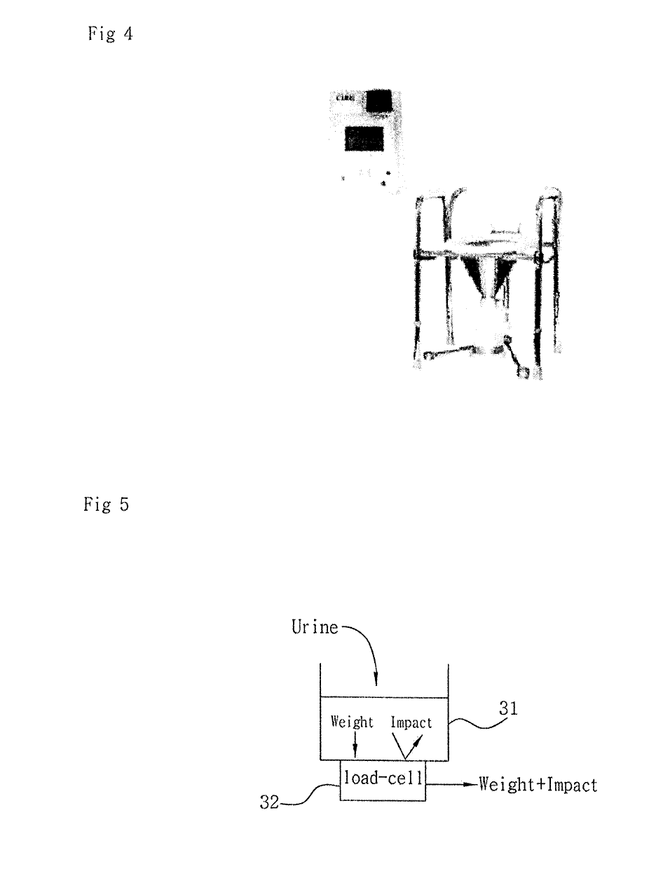

### DETAILED DESCRIPTION OF THE INVENTION

Hereinafter, exemplary embodiments of the present invention will be described in detail with reference to accompanying drawings, so that those skilled in the art can work with the embodiments.

Prior to the description about the present invention, a scheme of measuring a water pressure P applied to the present invention will be described below.

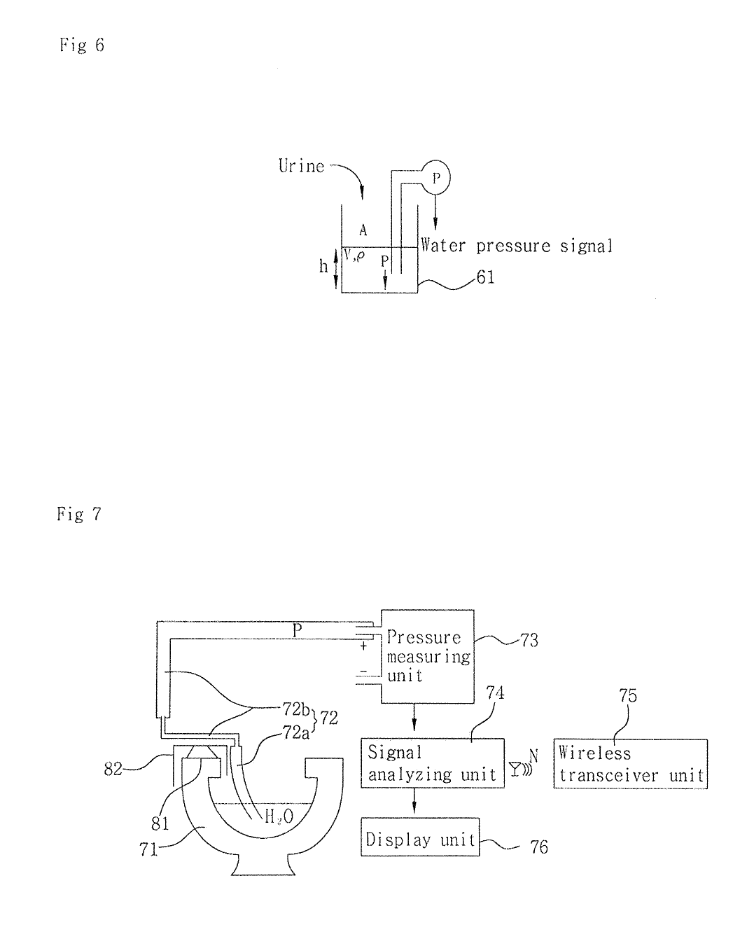

According to the scheme of measuring the water pressure P, as shown in FIG. 6, when urine is collected into a container 61 having a predetermined sectional area A, the water pressure P occurring on the bottom surface of the container 61 is measured. The water pressure P of the collected urine is proportional to the height h of the collected urine.

The relation between the water pressure P and the height h is expressed as Equation 1.

P=ρgh=pgV/A Equation 1

In Equation 1, the ρ represents the density of the urine, that is, 1, and the g represents a predetermined gravitational constant. Since the volume V of the urine is given as A×h, the water pressure P measured in the container 61 is proportional to the volume V.

In other words, since the water pressure P at the bottom surface of the container 61 is proportional to the volume V of the collected urine, a signal of a urinary flow rate can be measured in the same manner as that of a water pressure signal P, so that the examination can be performed.

Hereinafter, a uroflowmeter attachable to a toilet according to the present invention with the scheme of measuring the water pressure will be described with reference to accompanying drawings.

The uroflowmeter attachable to the toilet according to the present invention is installed in a household toilet to examine the urinary flow rate without an additional appliance differently from the scheme of measuring the urinary flow rate based on a weight measurement scheme according to the related art.

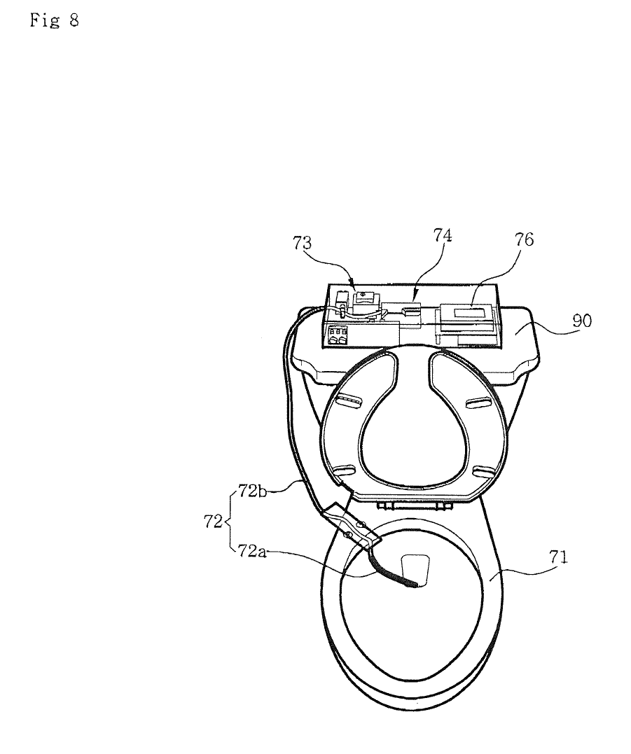

As shown in FIGS. 7 and 8, the uroflowmeter attachable to the toilet according to the present invention includes a toilet bowl 71 for temporarily storing feces and urine, a connection tube 72 for pressure measurement, which has one end introduced into water (H₂O) of the toilet bowl 71, a pressure measuring unit 73 connected to an opposite end of the connection tube 71 to measure the pressure inside the toilet, a signal analyzing unit 74 for analyzing pressure signals from the pressure measuring unit 73 to measure a volume signal and a urinary flow rate signal, a wireless transceiver unit 75 for making data communication with the signal analyzing unit 74 in a wireless way, and a display unit 76 for displaying the urinary flow rate signal measured by the signal analyzing unit 74.

The connection tube 72 includes a copper tube 72a having one end inserted into the water of the toilet bowl 71 and a connection hose 72b connecting the copper tube 72a with the pressure measuring unit 73. The connection hose 72b includes silicon, and is in a vacuum state.

A part of the connection tube 72 inserted into the toilet bowl 71 is the copper tube 72a with a heavier weight instead of a silicon tube. If the tube of the connection tube 72 inserted into the toilet bowl 71 includes a lighter material having flexibility, water is fluctuated when urine is put into the water, so that the tube inserted into the toilet bowl 71 may be shaken. Accordingly, impact noise is caused, so that a pressure signal cannot be exactly measured.

In addition, the copper tube 72a has a sufficient length such that one end thereof is submerged into the water filled in the toilet bowl 71. The internal diameter of the copper tube 72a is in the range of about 5 mm to about 15 mm to prevent a water membrane from being generated.

The pressure measuring unit 73 includes first and second terminals at one side thereof. The first terminal serves as a positive terminal (+) connected to the connection tube 72, and the second terminal serves as a negative terminal which is in an open state so that air pressure is delivered through the negative terminal.

The connection tube 72 is fixed to a portion of the edge of the toilet bowl 71 by a support plate 82 attached through a vacuum unit 81. In addition, a water tank 90 is provided at a rear upper portion of the toilet bowl 71, and the pressure measuring unit 73, the signal analyzing unit 74, the wireless transceiver unit 75, and the display unit 76 are installed at the upper portion of the water tank 90.

FIG. 8 is a photograph showing the uroflowmeter according to the present invention attached to a household toilet.

According to the scheme of measuring the urinary flow rate by the uroflowmeter attachable to the toilet of the present invention, as shown in FIGS. 7 and 8, if an examinee urinates into the toilet bowl 72 having the connection tube 72, the water surface of the toilet bowl 72 is raised by an amount of introduced urine.

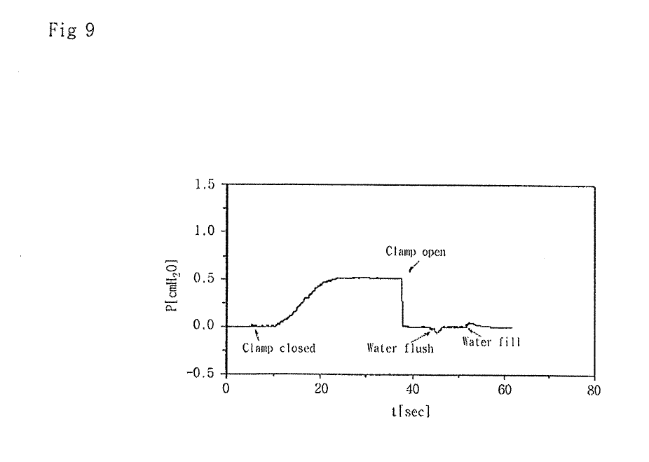

Then, the pressure measuring unit 73 measures a pressure P according to a time t by employing the scheme of measuring a water pressure as shown in FIG. 9 when the water surface is raised by an amount of urine while the examinee is urinating.

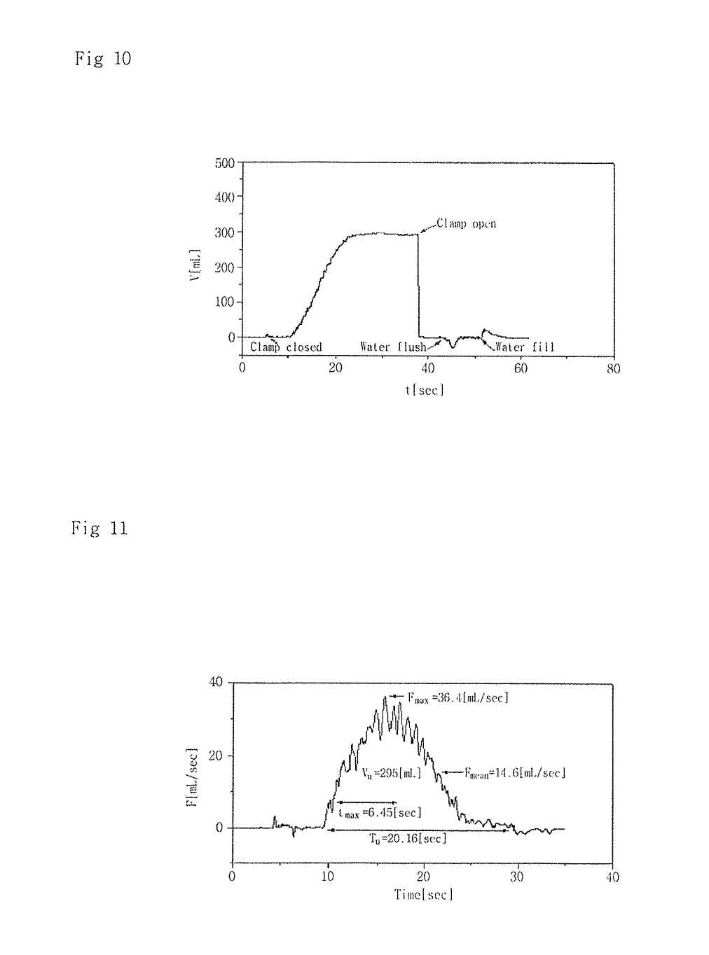

After the pressure measuring unit 73 measures the pressure P according to the time t as described above, the signal analyzing unit 74 calculates an amount V of the urine introduced into the toilet bowl 71 based on the pressure P as shown in the graph of FIG. 10. In this case, an amount V of the urine is calculated by measuring a height h of the water of the toilet bowl 71 after the examinee urinates and substituting a given base area A of the toilet bowl 71 into Equation 1,

Then, after the volume V of the urine measured by the signal analyzing unit 74 is differentiated with respect to time, the signal of the urinary flow rate according to the time is obtained as shown in the graph of FIG. 11. Diagnosis parameters obtained in the above manner are displayed on the display unit 76. In this case, the signal of the urinary flow rate shown in FIG. 11 is displayed with the maximum urinary flow rate Fmax and the average urinary flow rate Fmean.

As describe above, in the uroflowmeter attachable to the toilet according to the present invention, since a toilet bowl is directly used without an additional urine collecting container, urine can be removed only by flushing water without an inconvenient process of empting the urine collecting container after the urinary flow rate has been checked. Accordingly, the urinary flow rate can be conveniently and sanitarily checked.

In addition, even if the connection tube 72 for pressure measurement is always inserted in a household toilet, persons other than the examinee do not feel inconvenience, and the connection tube 72 does not exert a bad influence on the function of the toilet.

In addition, after examining the urinary flow rate of a user at home by using the uroflowmeter attachable to the toilet according to the present invention, the user can check and transmit the urinary flow rate signal and the diagnosis parameters through the wireless transceiver unit 75 at the outside, so the information communication with a remote plate, such as a hospital, is possible by using the uroflowmeter.

In addition, since the examinee can be examined by using a household toilet, the urinary flow rate of the examinee can be more comfortably checked. Accordingly, the examinee can be examined in a normal physiology state, so that reliable check results can be obtained.

Further, the examinee can rapidly view the check results of the examinee through the display unit 76 when the urinary flow rate is checked. Since most BDH patients are old-aged men, the display unit 76 is very advantageous to the old-aged men who are unfamiliar with the use of a computer (PC) or other devices.

Since the display unit 76 is equipped with a memory function, check data can be stored in the memory. Accordingly, the check results can be viewed thereafter.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A uroflowmeter attachable to a toilet comprising:
a toilet bowl for temporarily storing feces and urine;
a connection tube which has one end introduced into water of the toilet bowl;
a pressure measuring unit connected with an opposite end of the connection tube to measure pressure inside the toilet bowl;
a signal analyzing unit for analyzing pressure signals from the pressure measuring unit to measure a urinary volume signal and a urinary flow rate signal;
a display unit for displaying the urinary flow rate signal measured by the signal analyzing unit; and
a wireless transceiver unit for making data communication with the signal analyzing unit in a wireless way.

2. The uroflowmeter of claim 1, wherein the connection tube includes a copper tube having one end inserted into the water of the toilet bowl and a connection hose connecting the copper tube with the pressure measuring unit.

3. The uroflowmeter of claim 2, wherein the copper tube has an internal diameter in a range of about 5 mm to about 15 mm to prevent a water membrane from being generated.

4. The uroflowmeter of claim 2, wherein the connection hose includes a silicon tube.

5. The uroflowmeter of claim 1, wherein the pressure measuring unit is provided at one side thereof with a first terminal connected to the connection tube and a second terminal in an open state so that air pressure is delivered through the second terminal.

6. The uroflowmeter of claim 1, wherein the connection tube is fixed to a portion of an edge of the toilet bowl.

7. The uroflowmeter of claim 6, wherein the connection tube is fixed by a support plate attached through a vacuum unit.

8. The uroflowmeter of claim 1, wherein the display unit has a memory function.
